(19) United States
(12) Patent Application Publication
(10) Pub. No.: US 2025/0084986 A1
(43) Pub. Date: Mar. 13, 2025

(54) Ear Light Device

(71) Applicant: Mark Wentz, Mansfield, OH (US)

(72) Inventor: Mark Wentz, Mansfield, OH (US)

(21) Appl. No.: 18/537,995

(22) Filed: Dec. 13, 2023

Related U.S. Application Data
(60) Provisional application No. 63/581,763, filed on Sep. 11, 2023.

(51) Int. Cl. F21V 21/088; F21V 23/04

(52) U.S. Cl. CPC F21V 21/088; F21V 23/04; F21W 2121/06; F21Y 2115/10

(57) ABSTRACT

An ear light device that provides for shining light through the user's ears. The ear light device comprises a body component with a plurality of clip-on LED lights. The body component is installed behind the ears via a small, comfortable clip that fastens to the top of the ear. Further, the device can be charged with a small USB plug that is inserted into an electrical outlet. Also, the LED lights are available in several different colors and sizes. When the user turns the lights on, the device will glow with an intensity that will shine through the ear and give off an appearance of the ear glowing red or other colors. The lights may be used for decoration, such as on special occasions or holidays.

### CROSS-REFERENCE TO RELATED APPLICATION

The present application claims priority to, and the benefit of, U.S. Provisional Application No. 63/581,763, which was filed on Sep. 11, 2023, and is incorporated herein by reference in its entirety.

### FIELD OF THE INVENTION

The present invention relates generally to the field of ear light devices. More specifically, the present invention relates to an LED light accessory that can be clipped onto the ears. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in ear light devices. Generally, people may enjoy dressing up for different special occasions like birthday parties, holidays (i.e., Halloween), social events (i.e., costume parties), and much more. Adding different accessories to clothing and the body can be fun and entertaining. People may be looking for new and more unique accessories to wear with their costumes.

Further, people are always looking for more unusual and unique costume accessories to wear to parties and other social gatherings. Additionally, people may want unique and unusual accessories to wear even when just going to a club, dancing, or other social gatherings. Accordingly, it would be desirable to provide a unique accessory for users to wear when going to special events, clubs, parties, etc.

Thus, there is a demand for an improved ear light device that provides users with an LED light accessory that can be clipped onto the ears. More particularly, there is a demand for an ear light device that allows users to illuminate their ears to accentuate a costume or outfit.

Therefore, there exists a long-felt need in the art for an car light device that provides users with an LED light accessory that can be clipped onto the cars. There is also a long-felt need in the art for an car light device that features several small LED light bulbs installed within the clip that can illuminate light through the car and make it appear as if the car is glowing red or other colors. Further, there is a long-felt need in the art for an ear light device that allows users to illuminate their cars with an intensity to accentuate a costume or outfit. Moreover, there is a long-felt need in the art for a device that offers a way to decorate and customize a different area of the body for fun and entertainment. Further, there is a long-felt need in the art for an car light device that is charged with a small USB plug inserted into an electrical outlet. Finally, there is a long-felt need in the art for an ear light device that provides lights in several different colors and sizes.

The subject matter disclosed and claimed herein, in one embodiment thereof, comprises an car light device. The device provides for shining light through the user's ears. The car light device comprises a body component with a plurality of clip-on LED lights. The body component is installed behind the cars via a small, comfortable clip that fastens to the top of the car. Further, the device can be charged with a small USB plug that is inserted into an electrical outlet. Also, the LED lights are available in several different colors and sizes. When the user turns the lights on, the device will glow with an intensity that will shine through the car and give off an appearance of the car glowing red or other colors. The lights may be used for decoration, such as on special occasions or holidays.

In this manner, the car light device of the present invention accomplishes all of the foregoing objectives and provides users with a device that illuminates a user's cars. The device is an LED light accessory for a user's cars. The LED lights are available in different colors and sizes.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an car light device. The device provides for shining light through the user's cars. The car light device comprises a body component with a plurality of clip-on LED lights. The body component is installed behind the cars via a small, comfortable clip that fastens to the top of the car. Further, the device can be charged with a small USB plug that is inserted into an electrical outlet. Also, the LED lights are available in several different colors and sizes. When the user turns the lights on, the device will glow with an intensity that will shine through the car and give off an appearance of the car glowing red or other colors. The lights may be used for decoration, such as on special occasions or holidays.

In one embodiment, the car light device is disclosed that is not cumbersome, has a compact power source, and is easy to position on a user's car for use.

In one embodiment, the car light device comprises a body component. The body component preferably has a rounded arch to mimic the shape of a user's car, however the body component can be any suitable size and/or shape as is known in the art, depending on the wants and/or needs of a user and/or the shape and size of the user's car. Typically, the body component comprises opposing top and bottom surfaces, opposing right and left sides, and opposing ends. The body component is preferably made of a flexible, soft-molded polyvinyl chloride (PVC) material. Alternately, the body component can be made of foam rubber or hard plastic, i.e., high impact polystyrene (HIPS) and/or ABS. The preferred embodiment of the body component is configured for wearing behind a user's car, specifically behind the user's crest of the helix part of the outer car. However, the body component can also be adjustable, as needed.

In one embodiment, the body component also comprises a power source. In this embodiment, the power source is at least one battery, typically a rechargeable battery. The power source may also comprise an adaptor jack to receive power from an alternative power supply, such as an AC source or an additional battery pack. The adaptor jack can alternatively be used to recharge the batteries used as the power source.

In one embodiment, the body component comprises a plurality of light components. The light components are preferably mounted on the rounded arch of the body component, but can be mounted in any suitable position as is known in the art. The plurality of light components can be a lamp, a bulb, or a light emitting diode (LED). Specifically, the plurality of light components are coupled to the power source and configured so as to illuminate the user's car when directed by a user by operating a switch. The light components are preferably light emitting diodes (LEDs) that have the ability to change into a plurality of colors selected by a user during operation of the device.

In one embodiment, the body component may be comprised of a transparent or translucent material to allow for the transmission of light from the interior of the body component to the exterior of the body component. Further, the body component includes various electronic components, including, but not limited to, the power source, a power switch, and various circuitry to facilitate operation. The power source may be a battery, such as a commonly available button style battery, such as, but not limited to, a Zinc-air battery or AG2 sized alkaline or lithium-based battery. Alternately the power source may be of a rechargeable type, wherein the device may include a case for receiving the body component. The case may include a charging element to couple directly with the body component or with an exterior of the case, wherein the charging element comprises electronical contacts configured for coupling to a corresponding pair of electrical contacts positioned on the body component and/or the case.

In one embodiment, the power source is a 6V button cell cylindrical alkaline battery. Alternately, in another embodiment, the power source is two 3-volt lithium batteries, or a standard AAA battery can be used, depending on the desired cost and battery life. Other power source alternatives are, i.e., fuel cells and rechargeable NiCad batteries.

In one embodiment, the light components are preferably an ultra-bright white LED. Another preferred LED is a 3V LED white clear super bright. Alternatively, the light component can consist of multiple LEDs for increased illumination. Battery life (or AC power usage), brightness and cost can each affect the choice of the light components for the invention. Furthermore, any suitable color or size of LED can be utilized, as is known in the art. In one example, the plurality of LEDs can change color and/or rotate through and blink different colors.

In one embodiment, the power switch is integrated with the body component. Alternately, the power switch can be a button, a rocker switch, or a lever switch. The power switch can also act as a dimmer or to change LED colors, or to rotate through several colors. Further, the body component preferably comprises a switch bump proximate to the switch. The bump allows a user to feel by touch when the switch has been moved to either the “on” or “off” position by the power switch's proximity to the switch bump. Alternately, the switch bump can be lit to indicate when the power for the device is “on.”

In one embodiment, the body component comprises a clip component. The clip component can be any suitable clip as is known in the art. Further, the clip component can be any suitable shape and size as is known in the art. The clip component is used to secure the device to a user's car. After the clip component is clipped onto the user's car, the body component is positioned behind the car to illuminate the car with the LEDs. Further, the clip component is strong enough to secure the device to a user's car but also light enough that the device does not cause pain to the user. This makes the device very comfortable for the user, but will not pull loose off the car.

In one embodiment, the light component may be a design element, such as, but not limited to, an illuminated design, logo, slogan, shape, message, monogram, or other similar design.

In another embodiment, the device may include additional electronic components in the form of speakers, receivers, transmitters, communicators, and other common electronic components used in headphones, wherein the device may block noise and play audio from a connected device.

In yet another embodiment, the car light device comprises a plurality of indicia.

In yet another embodiment, a method of illuminating an car with a plurality of lights is disclosed. The method includes the steps of providing an car light device comprising a body component with a plurality of LED lights and a clip component. The method also comprises utilizing the clip component to secure the body component to a user's car. Further, the method comprises turning on the plurality of LED lights on the body component. Finally, the method comprises adjusting the plurality of LED lights such that the user's car is illuminated and glows red or other colors.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the ear light device of the present invention showing the device and charging cord in accordance with the disclosed architecture;

FIGS. 2A-B illustrate a perspective view of one embodiment of the ear light device of the present invention showing the LED lights of the device in accordance with the disclosed architecture;

FIG. 3 illustrates a perspective view of one embodiment of the ear light device of the present invention showing device being charged in accordance with the disclosed architecture;

FIGS. 4A-B illustrate a perspective view of one embodiment of the ear light device of the present invention showing the device secured to a user's ear in accordance with the disclosed architecture;

FIG. 5 illustrates a perspective view of one embodiment of the ear light device of the present invention showing the device illuminated in use in accordance with the disclosed architecture; and

FIG. 6 illustrates a flowchart showing the method of illuminating an ear with a plurality of lights in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an car light device that provides users with an LED light accessory that can be clipped onto the cars. There is also a long-felt need in the art for an car light device that features several small LED light bulbs installed within the clip that can illuminate light through the car and make it appear as if the car is glowing red or other colors. Further, there is a long-felt need in the art for an car light device that allows users to illuminate their cars with an intensity to accentuate a costume or outfit. Moreover, there is a long-felt need in the art for a device that offers a way to decorate and customize a different area of the body for fun and entertainment. Further, there is a long-felt need in the art for an car light device that is charged with a small USB plug inserted into an electrical outlet. Finally, there is a long-felt need in the art for an car light device that provides lights in several different colors and sizes.

The present invention, in one exemplary embodiment, is a novel ear light device. The device provides for shining light through the user's ears. The car light device comprises a body component with a plurality of clip-on LED lights. The body component is installed behind the cars via a small, comfortable clip that fastens to the top of the ear. Further, the device can be charged with a small USB plug that is inserted into an electrical outlet. Also, the LED lights are available in several different colors and sizes. The present invention also includes a novel method of illuminating an ear with a plurality of lights. The method includes the steps of providing an car light device comprising a body component with a plurality of LED lights and a clip component. The method also comprises utilizing the clip component to secure the body component to a user's car. Further, the method comprises turning on the plurality of LED lights on the body component. Finally, the method comprises adjusting the plurality of LED lights such that the user's car is illuminated and glows red or other colors.

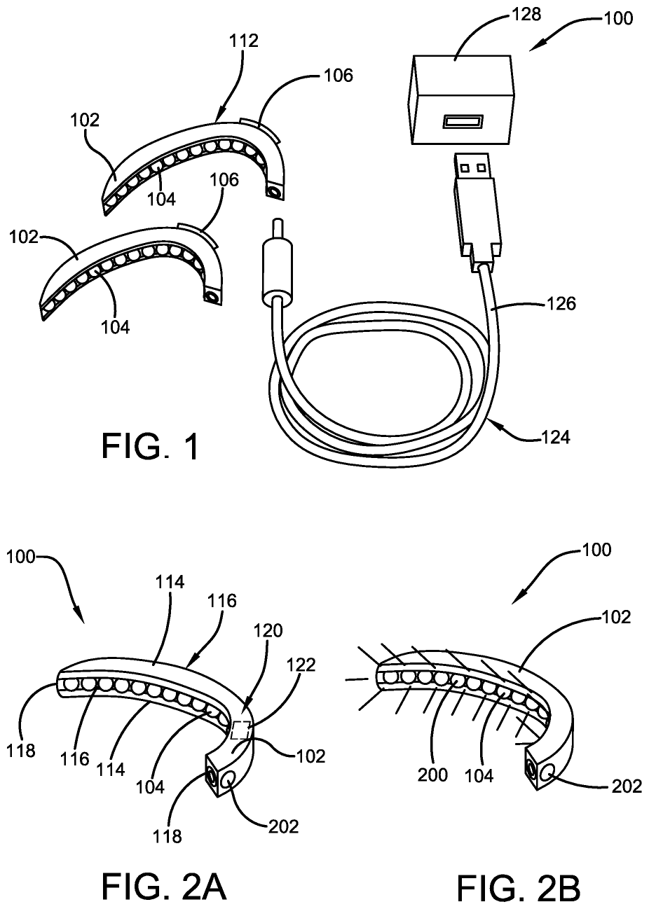

Referring initially to the drawings, FIG. 1 illustrates a perspective view of one embodiment of the car light device 100 of the present invention. In the present embodiment, the car light device 100 is an improved car light device 100 that provides a user 110 with a device 100 for shining light through a user's ears 108. Specifically, the car light device 100 comprises a body component 102 with a plurality of LED lights 104 and a clip component 106 for securing the device 100 to a user's cars 108. When the user 110 turns the LED lights 104 on, they will glow with an intensity that will shine through the ear 108 and give off an appearance of the car 108 glowing red (or other suitable colors). The device 100 may be used for decoration, such as on special occasions or holidays or going out to a club or party, etc.

Generally, the car light device 100 is disclosed that is not cumbersome, has a compact power source and is easy to position on a user's car 108 for use.

Furthermore, the car light device 100 comprises a body component 102. The body component 102 preferably has a rounded arch 112 to mimic the shape of a user's car 108, however the body component 102 can be any suitable size and/or shape as is known in the art, depending on the wants and/or needs of a user 110 and/or the shape and size of the user's car 108. Typically, the body component 102 comprises opposing top and bottom surfaces 114, opposing right and left sides 116, and opposing ends 118.

Additionally, the body component 102 is preferably made of a flexible, soft molded polyvinyl chloride (PVC) material. Alternately, the body component 102 can be made of foam rubber or hard plastic, i.e., high impact polystyrene (HIPS) and/or ABS, or any other suitable material as is known in the art. The preferred embodiment of the body component 102 is configured for wearing behind a user's ear 108, specifically behind the user's crest of the helix part of the outer car 108. However, the body component 102 can also be adjustable, as needed and placed in any suitable position on a user's car 108 as desired.

Furthermore, the body component 102 also comprises a power source 120. In this embodiment, the power source 120 is at least one battery, typically a rechargeable battery 122. The power source 120 may also comprise an adaptor jack 124 to receive power from an alternative power supply, such as an AC source or an additional battery pack. The adaptor jack 124 can alternatively be used to recharge the batteries 122 used as the power source 120. Further, in one embodiment, the adaptor jack 124 is an USB plug 126 and charger 128 that can be inserted into an electrical outlet 130 for charging the power source 120 (i.e., the batteries 122). However, any suitable charger can be utilized as is known in the art.

As shown in FIGS. 2A-B, the body component 102 comprises a plurality of light components 104. The light components 104 are preferably mounted on the rounded arch 112 of the body component 102, but can be mounted in any suitable position as is known in the art. The plurality of light components 104 can be a lamp, a bulb or a light emitting diode (LED) 200. Specifically, the plurality of light components 104 are coupled to the power source 120 and configured so as to illuminate the user's car 108 when directed by a user 110 by operating a power switch 202. The light components 104 are preferably light emitting diodes (LEDs) 200 that have the ability to change into a plurality of colors selected by a user 110 during operation of the device 100.

In one embodiment, the light components 104 are preferably an ultra-bright white LED. Another preferred LED is a 3V LED white clear super bright. Alternatively, the light component 104 can consist of multiple LEDs 200 for increased illumination. Battery life (or AC power usage), brightness and cost can each affect the choice of the light components 104 for the invention. Furthermore, any suitable color or size of LED 200 can be utilized, as is known in the art. In one example, the plurality of LEDs 200 can change color and/or rotate through and blink different colors, as desired.

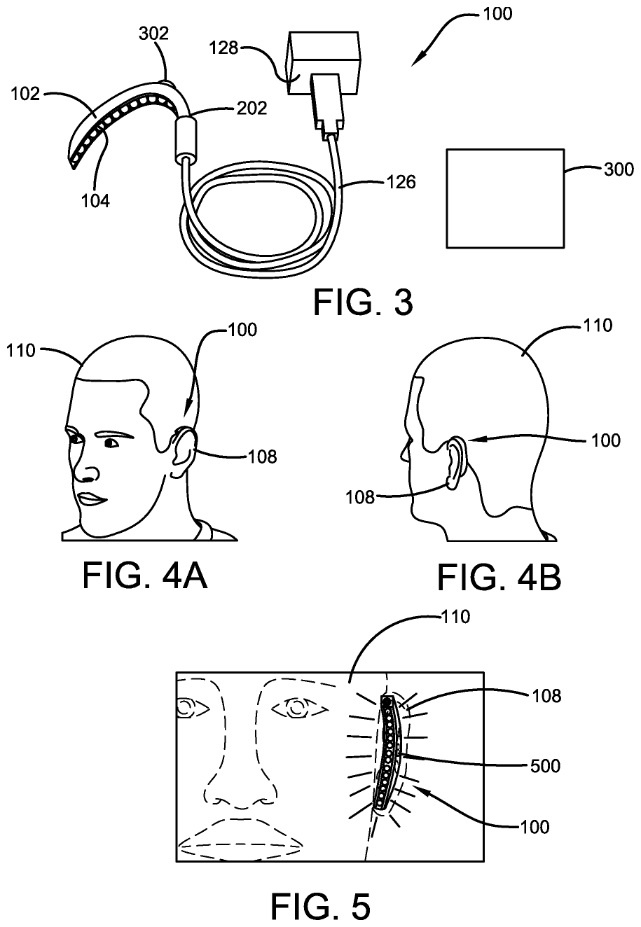

As shown in FIG. 3, the body component 102 may be comprised of a transparent or translucent material to allow for the transmission of light from the interior of the body component 102 to the exterior of the body component 102. Further, the body component 102 includes various electronic components, including, but not limited to, the power source 120, a power switch 202, and various circuitry to facilitate operation. The power source 120 may be a battery 122, such as a commonly available button style battery, such as, but not limited to, a Zinc-air battery or AG2 sized alkaline or lithium-based battery. Alternately the power source 120 may be of a rechargeable type, such as a rechargeable battery 122.

In one embodiment, the power source 120 is a 6V button cell cylindrical alkaline battery. Alternately, in another embodiment, the power source 120 is two 3-volt lithium batteries or a standard AAA battery can be used, depending on the desired cost and battery life. Other power source 120 alternatives are, i.e., fuel cells and rechargeable NiCad batteries, etc.

Specifically, the battery 122 may be a disposable battery or a rechargeable battery in the form of an alkaline, nickel-cadmium, nickel-metal hydride battery, etc., such as any 3V-12 volts DC battery or other conventional battery, such as A, AA, AAA, etc., that supplies power to the car light device 100. Throughout this specification, the term “battery” may be used interchangeably to refer to one or more wet or dry cells or batteries of cells in which chemical energy is converted into electricity and used as a source of DC power. References to recharging or replacing the battery 122 may refer to recharging or replacing individual cells, individual batteries of cells, or a package of multiple battery cells as is appropriate for any given battery technology that may be used. In addition, a rechargeable embodiment of the battery 122 may be recharged using a USB port (not shown), wherein the USB port is a USB-A, USB-B, Micro-B, Micro-USB, Mini-USB, or USB-C port, etc.

In another embodiment, the device 100 includes a case 300 for receiving the body component(s) 102. The case 300 may include a charging element 302 to couple directly with the body component 102 or with an exterior of the case 300, wherein the charging element 302 comprises electronical contacts configured for coupling to a corresponding pair of electrical contacts positioned on the body component 102 and/or the case 300.

Furthermore, the body component 102 comprises a power switch 202 that is integrated with the body component 102. The power switch 202 can be positioned in any suitable position on the body component 102, as is known in the art. Alternately, the power switch 202 can be a button, a rocker switch, or a lever switch, etc., or any other suitable power switch as is known in the art. The power switch 202 can also act as a dimmer or to change LED colors, or to rotate through several light colors, as desired. Further, the body component 102 preferably comprises a switch bump 302 proximate to the power switch 202. The bump 302 allows a user 110 to feel by touch when the switch bump 202 has been moved to either the “on” or “off” position by the power switch's proximity to the switch bump 302. Alternately, the switch bump 302 can be lit to indicate when the power for the device 100 is “on.”

As shown in FIGS. 4A-B, the body component 102 comprises a clip component 106. The clip component 106 can be any suitable clip or attachment device as is known in the art. Further, the clip component 106 can be any suitable shape and size as is known in the art. The clip component 106 is used to releasably secure the device 100 to a user's ear 108. The device can be secured to any suitable position on the car 108, depending on the wants and/or needs of a user 110. After the clip component 106 is clipped onto the user's car 108, the body component 102 is positioned behind the car 108, to illuminate the car 108 with the LEDs 200. Further, the clip component 106 is strong enough to secure the device 100 to a user's ear 108 but also light enough that the device 100 does not cause pain for the user 110. This makes the device 100 very comfortable for the user 110, but still prevents the device 100 from pulling loose off the user's car 108.

As shown in FIG. 5, the car light device 100 comprises a plurality of indicia 500. The body component 102 of the device 100 may include advertising, a trademark, or other letters, designs, or characters, printed, painted, stamped, or integrated into the body component 102, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be car, light, or brand related.

In one embodiment, the light component 104 may be a design element, such as, but not limited to, an illuminated design, logo, slogan, shape, message, monogram, or other similar design, etc.

In another embodiment, the device 100 may include additional electronic components in the form of speakers, receivers, transmitters, communicators, and other common electronic components used in headphones, wherein the device 100 may block noise and play audio from a connected device.

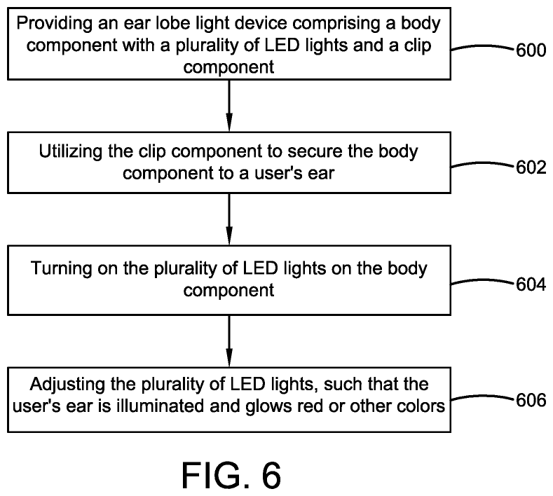

FIG. 6 illustrates a flowchart of the method of illuminating an car with a plurality of lights. The method includes the steps of at 600, providing an ear light device comprising a body component with a plurality of LED lights and a clip component. The method also comprises at 602, utilizing the clip component to secure the body component to a user's car. Further, the method comprises at 604, turning on the plurality of LED lights on the body component. Finally, the method comprises at 606, adjusting the plurality of LED lights such that the user's car is illuminated and glows red or other colors.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “car light device”, “light device”, “car device”, and “device” are interchangeable and refer to the car light device 100 of the present invention.

Notwithstanding the foregoing, the car light device 100 of the present invention can be of any suitable size and configuration as is known in the art without affecting the overall concept of the invention, provided that it accomplishes the above-stated objectives. One of ordinary skill in the art will appreciate that the ear light device 100 as shown in FIGS. 1-6 is for illustrative purposes only, and that many other sizes and shapes of the ear light device 100 are well within the scope of the present disclosure. Although the dimensions of the ear light device 100 are important design parameters for user convenience, the ear light device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An ear light device that provides a user with a device for shining light through a user's ears, the ear light device comprising:
a body component;
a plurality of light components; and
a clip component;
wherein the plurality of light components are positioned on the body component;
wherein the body component is sized and shaped to fit behind a user's ear;
wherein the clip component acts to secure the body component to the user's ear, as desired; and
further wherein when the plurality of light components are turned on, the plurality of light components will glow with an intensity that will shine through the user's ear, creating an appearance that the user's ear is glowing red or other colors.

2. The ear light device of claim 1, wherein the body component preferably has a rounded arch to mimic shape of the user's ear.

3. The ear light device of claim 2, wherein the body component comprises opposing top and bottom surfaces, opposing right and left sides, and opposing ends.

4. The ear light device of claim 3, wherein the body component is preferably made of a flexible, soft molded polyvinyl chloride (PVC) material.

5. The ear light device of claim 4, wherein the body component is configured for wearing behind a user's ear, specifically behind a user's crest of a helix part of the ear.

6. The ear light device of claim 5, wherein the body component comprises a power source.

7. The ear light device of claim 6, wherein the power source is at least one rechargeable battery.

8. The ear light device of claim 7, wherein the power source comprises an adaptor jack to receive power from an alternative power supply, such as an AC source or an additional battery pack, or to recharge the at least one rechargeable battery.

9. The ear light device of claim 8, wherein the adaptor jack is an USB plug and charger that can be inserted into an electrical outlet for charging the power source.

10. The ear light device of claim 9, wherein the plurality of light components are mounted on the rounded arch of the body component.

11. The ear light device of claim 10, wherein the plurality of light components are a plurality of light emitting diodes (LEDs) that have ability to change into a plurality of colors selected by a user during operation of the ear light device.

12. The ear light device of claim 11, wherein the body component comprises multiple electronic components, including, the power source, a power switch, and various circuitry to facilitate operation.

13. The ear light device of claim 12, wherein the power switch is integrated with the body component, and can also act as a dimmer or to change LED colors, or to rotate through several light colors, as desired.

14. An ear light device that provides a user with a device for shining light through a user's ears, the ear light device comprising:
a body component with a rounded arch and opposing top and bottom surfaces, opposing right and left sides, and opposing ends;
a plurality of LEDs mounted on the rounded arch of the body component that have ability to change into a plurality of colors; and
a clip component;
wherein the body component is sized and shaped to fit behind a user's ear, specifically behind a user's crest of a helix part of the ear;
wherein the body component comprises multiple electronic components, including, a rechargeable battery, a power switch, and various circuitry to facilitate operation;
wherein the power switch is integrated with the body component, and can also act as a dimmer or to change LED colors, or to rotate through several light colors;
wherein the clip component acts to secure the body component to the user's ear, as desired;
wherein the body component comprises an USB plug and charger that can be inserted into an electrical outlet for charging the rechargeable battery;
wherein the plurality of LEDs are coupled to the rechargeable battery and configured so as to illuminate the user's ear when directed by a user by operating the power switch; and
further wherein when the plurality of LEDs are turned on, the plurality of LEDs will glow with an intensity that will shine through the user's ear, creating an appearance that the user's ear is glowing red or other colors.

15. The ear light device of claim 14, wherein the body component is comprised of a transparent or translucent material to allow for transmission of light from interior of the body component to exterior of the body component.

16. The ear light device of claim 14, wherein the clip component is used to releasably secure the body component to the user's ear and is strong enough to secure the body component to the user's ear but also light enough that the body component does not become uncomfortable or pull loose from the user's ear.

17. The ear light device of claim 14 further comprising a case for receiving the body component, wherein the case includes a charging element to couple directly with the body component or with an exterior of the case.

18. The ear light device of claim 14 further comprising a switch bump proximate to the power switch, which allows a user to feel by touch when the power switch has been moved to either “on” or “off” position by the power switch's proximity to the switch bump.

19. The ear light device of claim 14 further comprising a plurality of indicia.

20. A method of illuminating an ear with a plurality of lights, the method comprising the following steps:
providing an ear light device comprising a body component with a plurality of LED lights and a clip component;
utilizing the clip component to secure the body component to a user's ear;
turning on the plurality of LED lights on the body component; and
adjusting the plurality of LED lights such that the user's ear is illuminated and glows red or other colors.
